(19) United States
(12) Patent Application Publication
(10) Pub. No.: US 2005/0159793 A1
(43) Pub. Date: Jul. 21, 2005

(54) Methods for treating macular degeneration

(76) Inventor: Jackson Streeter, Reno, NV (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/612,709

(22) Filed: Jul. 2, 2003

Related U.S. Application Data
(60) Provisional application No. 60/393,145, filed on Jul. 2, 2002.

(51) Int. Cl. A61H 21/00

(52) U.S. Cl. 607/86

(57) ABSTRACT

Therapeutic methods for treating or inhibiting macular degeneration in a subject in need thereof are described, the methods including applying to a macula of the subject a macular degeneration effective amount of electromagnetic energy having a wavelength in the visible to near-infrared wavelength. In one embodiment, a macular degeneration effective amount of laser energy is a predetermined power density (mW/cm²) of the electromagnetic energy of at least 0.01 mW/cm², which is provided from a laser or other light energy source.

### RELATED APPLICATION INFORMATION

This application claims priority under 35 U.S.C. § 119(e) to U.S. Provisional Patent Application No. 60/393,145, filed Jul. 2, 2002, the disclosure of which is hereby incorporated by reference in its entirety.

### BACKGROUND OF THE INVENTION

1. Field of the Invention

The present invention relates in general to therapeutic methods for the treatment of macular degeneration and more particularly to methods for treating macular degeneration by the application of electromagnetic energy.

2. Description of the Related Art

Age-related macular degeneration (AMD) is a chronic, progressive degeneration of cells in the macular area of the human retina, and is one of the most common causes of vision loss in individuals over the age of 65. Although some of the pathophysiological changes attending AMD are known, the underlying cause of the disease is unknown, and no known cure exists. AMD affects an estimated 25% of people aged 70 and over, with about 10% having several symptoms and about 1% progressing to total blindness.

The distortion and loss of central vision that characterizes AMD occurs as a result of atrophy of the retinal pigment epithelium (RPE). Post mortem anatomical studies of atrophic cells in AMD patients reveal destruction of RPE cells, with clumped pigment adhering to Bruch's membrane. The pathophysiology of end stage macular degeneration includes atrophy and death of macular cells, and in many cases also neovascularization in which new abnormal blood vessels invade beneath the retina preferentially in macular regions.

About 90% of AMD cases are characterized as “dry” macular degeneration, in which yellow deposits or “drusen” form between the RPE and Bruch's membrane under the retina. Drusen appear to be the result of compromised cell metabolism in the RPE, and eventually produce localized deterioration of macular regions of the retina, resulting in spotty loss of central-vision. About 10% of macular degeneration cases are characterized as “wet” macular degeneration in which a process of neovascularization near the drusen deposits produces abnormal vessels behind the macula that then leak and bleed. The result is macular scarring and rapid and severe distortion, or partial or total loss of central vision. The wet form of AMD presents as one of two types: classic and occult. Conventional laser photocoagulation, in which blood vessels are cauterized by the heat of a high energy laser beam, is known for treating the classic wet form of the disease, yet over 70% of patients with the wet form have instead the occult type which is not treatable with conventional laser photocoagulation. In addition, conventional laser photocoagulation merely stabilizes vision or limits neovascularization but does not improve already compromised vision. In addition, high energy laser treatment destroys overlying healthy macular tissue as well as abnormal vessels.

A technique termed photodynamic therapy exists for patients with “wet” macular degeneration. In photodynamic therapy the light-sensitive drug verteporfin (Visudyne®, Novartis Ophthalmics, Duluth, Ga.) is administered intravenously to the patient to circulate through the patient's vascular system, including abnormal microvessels beneath the retina. Using a slit lamp and optic fiber, a laser beam of wavelength 689 nm is then directed into the eye to the retina, at a dose of 50 J/cm² of neovascular lesion and at an intensity of 600 mW/cm, for a period of 83 seconds. The drug absorbs the light, destroying abnormal or leaky vessels in the retina. However, photodynamic therapy is limited to treating “wet” macular degeneration, and does not restore or rescue damaged retinal cells. Thus, even for patients with the wet form of AMD, photodynamic therapy is mainly limited to those with recent onset and no macular scarring.

In the field of surgery, high energy laser radiation is now well accepted as a tool for cutting, cauterizing, and ablating biological tissue, including cauterizing the abnormal vessel tissue in “wet” AMD patients. High energy lasers are now routinely used for vaporizing superficial skin lesions and, and to make deep cuts. For a laser to be suitable for use as a surgical laser, it must provide laser energy at a power sufficient to heat tissue to temperatures over 50° C. Power outputs for surgical lasers vary from 1-5 W for vaporizing superficial tissue, to about 100 W for deep cutting. Thus, high energy laser radiation has been used to reduce or eliminate the neovasularization that occurs in some patients during later stage macular degeneration. However, as explained above, high energy laser treatment can permanently damage healthy macular tissue. In addition, high energy laser treatment, where applicable, is not necessarily a permanent cure, because new vascularization may occur.

Against this background, a high level of interest remains in finding new and improved therapeutic methods for the treatment of macular degeneration.

### SUMMARY OF THE INVENTION

In accordance with a preferred embodiment, there is provided a method for treating or inhibiting macular degeneration in a subject in need of such treatment or inhibition includes applying to a region of a retina of the subject a macular degeneration effective amount of electromagnetic energy having a wavelength in the visible to near-infrared wavelength range.

In accordance with a preferred embodiment, there is provided method for treating or inhibiting macular degeneration, comprising applying to at least a portion of the macula of a subject in need of treatment or inhibition of macular degeneration, an amount of electromagnetic energy having a wavelength in the visible to near-infrared wavelength range and a power density sufficient to produce biostimulatory effects on said macula.

### DETAILED DESCRIPTION OF THE PREFERRED EMBODIMENT

The methods for treating macular degeneration disclosed herein involve the use of low level light therapy. It has been found that applying electromagnetic energy at a wavelength in the visible to near-infrared wavelength range to tissue appears to be especially effective at stimulating basic cellular biological processes underlying cellular growth, repair, regeneration, differentiation, and migration such that the biological processes underlying neuronal cell degeneration in diseases or conditions such as macular degeneration are inhibited or arrested.

The methods for treating or inhibiting macular degeneration described herein may be practiced using any appropriate source of light having the properties described herein. In a preferred embodiment, the methods use a handheld low level laser therapy apparatus such as that shown and described in U.S. Pat. Nos. 6,214,035, 6,267,780, 6,273,905, 6,290,714, and 5,312, 451, the disclosures of which are herein incorporated by reference in their entirety together with the references contained therein. In addition, the disclosures of all the primary references cited herein are incorporated by reference in their entirety together with any references contained therein.

The apparatus described in the patents referenced above includes a handheld probe for delivering laser energy. The probe includes a source of laser energy having a wavelength in the visible to near-infrared wavelength range, generally from about 630 nm to about 940 nm, including the range of about 780 nm to about 840 nm, including about 790, 800, 810, 820, and 830 nm. The probe includes, for example, a single laser diode that provides about 100 mW to about 500 mW of total power output, including about 200 mW, 300 mW, and 400 mW, or multiple laser diodes that together are capable of providing a total power output within this same range. In other embodiments, the probe may have an output lower than 100 mW, including about 1 mW, 5 mW, 10 mW, 20 mW, 30 mW, 40 mW, 50 mW, and 75 mW. The actual power output is variable using a control unit electronically coupled to the probe, so that power of the laser energy emitted can be adjusted in accordance with required power density calculations as described below. The diodes used may include continuous emitting GaAIAs laser diodes having a wavelength of about 830 nm. Alternatively, the electromagnetic energy source is another type of diode, for example a light-emitting diode (LE), or other light energy source, having a wavelength in the visible to near-infrared wavelength range. The level of coherence of a light energy source is not critical such that coherent and generally non-coherent sources, or a combination thereof, may be used. A light energy source used as the electromagnetic energy source need not provide light having the same level of coherence as the light provided by a laser energy source. Additionally, the light energy source can emit light continuously, as in the case of continuously emitting laser diodes, or emit pulsed light, as in the case of pulsed laser diodes. If light is pulsed, the pulses are preferably at least about 10 ns long and occur at a frequency of up to about 100 Hz. The light may be substantially monochromatic (one wavelength or a narrow band of wavelengths) or it may be of a broader spectrum.

The electromagnetic energy therapy methods are used to treat macular degeneration in human patients, particularly age-related macular degeneration of the wet or dry forms.

As used herein, the terms “biostimulative” and “biostimulatory” as used herein refer to a characteristic of an amount of electromagnetic energy delivered to macular cells in vivo, wherein the electromagnetic energy enhances basic cell biological functions such as respiration, protein synthesis and transport, intracellular and intracellular signaling, and cellular metabolism, that underlie cell activity involved in cell growth, repair, regeneration, differentiation and reproduction.

It has been found that in delivering electromagnetic energy to cells or to tissue, the power density (i.e. light intensity or power per unit area, in mW/cm²), may be an important factor in producing biostimulatory effects on cells that result in prevention or inhibition of the apoptotic or necrotic processes that occur secondarily to a primary disease, condition or insult to the tissue. Accordingly, in a preferred embodiment, the treatment of a subject suffering from macular degeneration, includes applying electromagnetic energy to a macular region of a subject, at a power density of at least 1 mW/cm² and no more than about 100 mW/cm². In related embodiments, the treatment includes applying electromagnetic energy to a macular region of a subject at a power density of about 0.01 mW/cm² and up to about 100 mW/cm², including about 0.05, 0.1, 0.5, 1, 5, 10, 15, 20, 30, 40, 50, 60, 70, 80, and 90 mW/cm². The power densities listed are power densities of the light that is applied; the actual power density at the level of the macular cells will be slightly less due to attenuation occurring as the light passes through the tissue and fluids between the light source and the macular cells. Macular cells treated with electromagnetic energy according to the present methods will preferably resist apoptosis, resist necrosis, and/or regain or at least retain sensory function. The treatment will, in preferred embodiments, enhance basic biological functions that support cell growth, differentiation and reproduction. Without being bound by theory, it is believed that electromagnetic energy applied to cells within the specified range of power densities, independently of the power and dosage of the electromagnetic energy used, produces a desired biostimulative effect. The biostimulative effect may be produced through effects on mitochondrial activity that supports the basic cellular functions and activity for growth, repair, regeneration, differentiation and reproduction.

A macular degeneration effective amount of electromagnetic energy as used herein includes a predetermined power density (mW/cm²) of electromagnetic energy applied to a macular region in the retina of the subject. The power density is sufficient to deliver a power density of energy to the retina that produces biostimulatory effects of the energy, taking into account factors that attenuate the energy as it travels from the exposed corneal surface, through the cornea, lens, etc. to the retina.

According to preferred methods for treating macular degeneration, the electromagnetic energy is applied to the retina by directing a light energy beam through the eye from the corneal surface to the retina. Any position of the light energy beam can be selected, provided that a beam of electromagnetic energy applied to the position is directed toward the macula. The macula is irradiated with electromagnetic energy having a wavelength in the visible to near-infrared wavelength range, using an energy source, preferably having a power output of about 1 mW to about 500 mW, including about 50 mW to about 500 mW. In an exemplary embodiment, the wavelength of the electromagnetic energy is 830 nm. The energy is applied to the macula at an approximate power density of preferably about 0.01 mW/cm² to about 100 mW/cm², including at least 1 mW/cm² to about 100 mW/cm². In one embodiment, the power density is about 2 mW/cm² to about 20 mW/cm².

In preferred embodiments, the treatment proceeds continuously for a period of about 1 second to about 2 hours, including for a period of about 1 to 20 minutes. The treatment is preferably applied on a regular basis for at least 2-3 days, and can continue indefinitely for as long as a trained therapist or physician determines that macular function is improving or at least that loss of function is arrested. The irradiation therapy can also be repeated on a daily, several-times daily, or alternate day basis or at other intervals determined by the trained therapist or physician to result in optimal therapeutic effects for the patient, considering one or more of various clinical factors such as the severity and stage of the macular degeneration, age of the subject, presence of other diseases or conditions, effectiveness of drug therapy, and the like. In an exemplary embodiment, the electromagnetic energy is applied to the macula using a back-and-forth scanning energy beam at a speed of about 1-2 cm per sec across the retina for a duration of 10 seconds to 20 minutes every alternate day for a period of about 2 months.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention.

1. A method for treating or inhibiting macular degeneration, comprising applying to at least a portion of the macula of a subject in need of treatment or inhibition of macular degeneration, an amount of electromagnetic energy having a wavelength in the visible to near-infrared wavelength range and a power density sufficient to produce biostimulatory effects on said macula.

2. A method in accordance with claim 1 wherein the power density is at least about 0.01 mW/cm².

3. A method in accordance with claim 1 wherein the power density is selected from the range of about 1 mW/cm² to about 100 mW/cm².

4. A method in accordance with claim 1 wherein the power density is selected from the range of about 20 mW/cm² to about 50 mW/cm².

5. A method in accordance with claim 1 wherein the electromagnetic energy has a wavelength of about 630 nm to about 904 nm.

6. A method in accordance with claim 5 wherein the electromagnetic energy has a wavelength of about 830 nm.

7. A method in accordance with claim 5 wherein the electromagnetic energy has a wavelength of about 780 nm to about 840 nm.

8. A method in accordance with claim 1 wherein applying the electromagnetic energy comprises providing a laser energy source.

9. A method in accordance with claim 1 wherein the electromagnetic energy comprises pulsed light.

10. A method for treating or inhibiting macular degeneration comprising applying to a region of a retina of a subject in need of such treatment or inhibition a macular degeneration effective amount of electromagnetic energy having a wavelength in the visible to near-infrared wavelength range.

11. A method in accordance with claim 10 wherein applying the electromagnetic energy comprises applying a predetermined power density of electromagnetic energy to the macula.

12. A method in accordance with claim 11 wherein the predetermined power density is a power density of at least about 0.01 mW/cm².

13. A method in accordance with claim II wherein the predetermined power density is a power density selected from the range of about 1 mW/cm² to about 100 mW/cm².

14. A method in accordance with claim 11 wherein the predetermined power density is selected from the range of about 20 mW/cm² to about 50 mW/cm².

15. A method in accordance with claim 10 wherein the electromagnetic energy has a wavelength of about 630 nm to about 904 nm.

16. A method in accordance with claim 15 wherein the electromagnetic energy has a wavelength of about 830 nm.

17. A method in accordance with claim 15 wherein the electromagnetic energy has a wavelength of about 780 nm to about 840 nm.

18. A method in accordance with claim 10 wherein applying the macular degeneration effective amount of electromagnetic energy further comprises providing a laser energy source for generating the electromagnetic energy.

19. A method in accordance with claim 10 further comprising a continuous light source for generating the electromagnetic energy.

20. A method in accordance with claim 10 further comprising a pulsed light source for generating the electromagnetic energy.
